(19) United States
(12) Patent Application Publication
(10) Pub. No.: US 2001/0055628 A1
(43) Pub. Date: Dec. 27, 2001

(54) Natural oils having a synergistic effect as a pesticide

(76) Inventors: Hsinhung John Hsu, Ventura, CA (US); Chun-Hua Chang, Ventura, CA (US)

Correspondence Address: RALPH D CHABOT, 2310 E PONDEROSA DR, SUITE 23, CAMARILLO, CA, 93010, US

(21) Appl. No.: 09/853,362

(22) Filed: May 10, 2001

Related U.S. Application Data
(60) Provisional application No. 60/203,787, filed on May 12, 2000.

(51) Int. Cl. A01N 65/00

(52) U.S. Cl. 424/736; 424/739; 424/745; 424/747; 424/750; 424/757; 424/755; 424/770

(57) ABSTRACT

The present invention is directed to a natural pesticide, which comprises two oil components. The first component is selected from at least one of the volatile oils and the other component is selected from at least one of the non-volatile oils. Mixing of these two oil components greatly increases the effectiveness for use as a pesticide than if the oils were used separately.

This application claims priority to U.S. provisional application bearing serial No. 60/203,787 filed on May 12, 2000.

### BACKGROUND

This invention relates to formulations to be used as natural pesticides comprising two oil components.

Both volatile and non-volatile oils have been used successfully in the past as natural pesticides. These oils are usually used individually or combined with other chemical pesticides for control of pests or plant diseases.

Volatile oils by their nature evaporate quickly when exposed to the atmosphere following application. Because of evaporation, the use of volatile oils as an effective and economical pesticide is substantially limited.

### SUMMARY OF INVENTION

Combining a volatile oil component with a non-volatile oil component yields a natural pesticide having improved pesticidal effectiveness than if an equivalent amount of either were used separately. It is believed this synergistic result may be due in part to the fact that the evaporative rate of the volatile oil is reduced when the volatile oil is combined with a non-volatile oil.

The combination of a non-volatile oil and a volatile oil may also exhibit improved spreading, coating and penetration of the surface of plants upon which it is applied increasing effectiveness in control of pests and/or plant diseases.

The volatile oils used to prepare the natural pesticide include cinnamon oil, rosemary oil, cedarwood oil, clove oil, sweet orange oil, and peppermint oil. However, other oils considered to be volatile oils such as citronella oil, pine oil, citrus oil, eucalyptus oil, camphor oil, etc., may also be used.

The non-volatile oils used to prepare the natural pesticide include cottonseed oil, corn oil, mineral oil, soybean oil, rapeseed oil, and vegetable oil. However, other non-volatile oils such as fish oil, etc., may also be used.

Preferably, the ideal weight ratio of volatile oil:non-volatile oil is between 1:10 and 10:1. An emulsifier can also be used in the formulation, from between 1% to 60% of the total weight of the concentrated natural pesticide. Suggested emulsifiers can be natural or synthetic. Preferably, sodium lauryl sulfate is used as the emulsifier. The concentrated natural pesticide can be diluted with water up to 2000 times prior to use.

### DETAILED DESCRIPTION

Samples of different oil combinations were prepared according to the following tables:

| | Cinnamon | Rosemary | Cedarwood | Cotton | | Mineral |
|---|---|---|---|---|---|---|
| | Oil | Oil | Oil | Seed Oil | Corn Oil | Oil |
| Sample 1 | 40 | — | — | 60 | — | — |
| Sample 2 | 40 | — | — | — | 60 | — |
| Sample 3 | 40 | — | — | — | — | 60 |
| Sample 4 | — | 40 | — | 60 | — | — |
| Sample 5 | — | 40 | — | — | 60 | — |
| Sample 6 | — | 40 | — | — | — | 60 |
| Sample 7 | — | — | 40 | 60 | — | — |
| Sample 8 | — | — | 40 | — | 60 | — |
| Sample 9 | — | — | 40 | — | — | 60 |

| | Clove | Sweet | Peppermint | Soybean | Rapeseed | Vegetable |
|---|---|---|---|---|---|---|
| | Oil | Orange Oil | Oil | Oil | Oil | Oil |
| Sample 10 | 40 | — | — | 60 | — | — |
| Sample 11 | 40 | — | — | — | 60 | — |
| Sample 12 | 40 | — | — | — | — | 60 |
| Sample 13 | — | 40 | — | 60 | — | — |
| Sample 14 | — | 40 | — | — | 60 | — |
| Sample 15 | — | 40 | — | — | — | 60 |
| Sample 16 | — | — | 40 | 60 | — | — |
| Sample 17 | — | — | 40 | — | 60 | — |
| Sample 18 | — | — | 40 | — | — | 60 |
| Sample 19 | 20 | 20 | — | 60 | — | — |
| Sample 20 | 10 | — | — | 90 | — | — |
| Sample 21 | 90 | — | — | 10 | — | — |

For purposes of presenting test results for the subsequent experiments, a disease index which represents the severity of the disease present on a plant was created. This is a subjective assessment and is categorized in the following manner:

| Scale | % Infection |
|---|---|
| 0 | 0 |
| 1 | 1-10 |
| 2 | 11-20 |
| 3 | 21-50 |
| 4 | 51-100 |

The disease index is calculated by the following formula:

$$DI = \frac{[ ( {S}_{0} {L}_{0} ) + ( {S}_{1} {L}_{1} ) + ( {S}_{2} {L}_{2} ) + ( {S}_{3} {L}_{3} ) + ( {S}_{4} {L}_{4} ) ] \times 100}{{L}_{total} \times 4}$$

Where DI=Disease index

S=Scale category (0, 1, 2, 3 or 4)

L=number of leaves per scale category

The degree of control represents the efficiency of the product in controlling the disease and is calculated by the following formula:

$$DC = \frac{[ {DI}_{non \text{-} treated area} - {DI}_{treated area} ] \times 100}{{DI}_{non \text{-} treated area}}$$

A degree of control of 0 represents no control and 100 represents total control of the disease.

### Experiment 1 (Powdery Mildew on Cucumber Plants)

Cinnamon, rosemary, and cedarwood oils were evaluated against and in combination with non-volatile cotton seed oil. Water was also used as a base standard. Samples 1, 4 and 7 were tested for the control of powdery mildew disease on cucumber plants. One gram of each sample was mixed with 98 grams of water and 1 gram of sodium lauryl sulfate (as emulsifier). Equivalent amounts of cinnamon oil, rosemary oil, cedarwood oil and cottonseed oil were also samples, diluted in the same manner and applied to plants for comparison. Four plants with powdery mildew disease were sprayed for each sample. The results one week after spray application were as follows:

| | Disease Index | Degree of Control |
|---|---|---|
| Sample 1 | 10.4 | 85.8% |
| Sample 4 | 18.3 | 75.0% |
| Sample 7 | 24.5 | 66.5% |
| Cinnamon Oil | 47.6 | 35.0% |
| Rosemary Oil | 50.9 | 30.5% |
| Cedarwood Oil | 53.1 | 27.5% |
| Cotton Seed Oil | 29.7 | 59.4% |
| Water | 73.2 | 0.0% |

Results from Experiment 1 indicate the combination of a volatile oil with non-volatile cotton seed oil is more effective than when either cotton seed oil or a volatile oil is applied separately for controlling powdery mildew disease on cucumber plants. The results indicate that cinnamon oil was more effective in combination with cotton seed oil than were either rosemary oil or cedarwood oil.

For this experiment, the non-volatile cotton seed oil was individually more effective than any of the volatile oils. However, the combination of cinnamon oil and cotton seed oil (Sample 1) exhibited at least a 44% improvement in the degree of control over either cinnamon oil or cotton seed oil separately.

### Experiment 2 (White Fly)

Cinnamon, rosemary, and cedarwood oils were evaluated against and in combination with either of the non-volatile oils: corn oil or mineral oil. Water was also used as a base standard.

Samples 2, 3, 5, 6, 8, and 9 were tested for the control of white flies on cucumber plants. One gram of each sample was mixed with 98 grams of water and 1 gram of sodium lauryl sulfate (as emulsifier). Equivalent amounts of cinnamon oil, rosemary oil, cedarwood oil, corn oil and mineral oil were also samples, diluted in the same manner and applied to plants for comparison. Each was diluted and sprayed onto 4 plants infested with adult white flies. The results are as follows:

| | White Flies | Dead White Flies | Mortality |
|---|---|---|---|
| | (before spraying) | (after spraying) | (%) |
| Sample 2 | 206 | 161 | 78.2 |
| Sample 3 | 187 | 133 | 71.6 |
| Sample 5 | 245 | 167 | 68.2 |
| Sample 6 | 192 | 128 | 66.7 |
| Sample 8 | 167 | 103 | 61.7 |
| Sample 9 | 188 | 112 | 59.6 |
| Cinnamon Oil | 237 | 121 | 51.1 |
| Rosemary Oil | 241 | 101 | 41.9 |
| Cedarwood Oil | 214 | 82 | 38.3 |
| Corn Oil | 196 | 82 | 41.8 |
| Mineral Oil | 258 | 124 | 48.1 |
| Water | 227 | 24 | 10.6 |

Results from Experiment 2 indicate the combination of a volatile oil with non-volatile corn oil or mineral oil is more effective than when either corn oil, mineral oil or a volatile oil is applied separately for controlling white flies.

The results indicate that cinnamon oil was more effective in combination with either corn oil or mineral oil than were either rosemary oil or cedarwood oil. For this experiment, cinnamon oil was individually more effective than any of the oils and was also most effective when used in combination with corn oil (Sample 2) or mineral oil (Sample 3). The combination of cinnamon oil and corn oil exhibited at least a 53% improvement in the pesticidal effectiveness over either cinnamon oil or corn oil used separately as indicated by the improved mortality of white flies.

The improved pesticidal effectiveness indicates a synergistic improvement for the control of white flies when either cinnamon, rosemary, or cedarwood oil is combined with either corn oil or mineral oil when contrasted to application of any of these oils separately.

### Experiment 3 (Control of Mites on Avocado Plants)

Volatile clove oil was evaluated against and in combination with one of the following non-volatile oils: soybean oil, rapeseed oil, or vegetable oil. Water was also used as a base standard. Samples 10, 11 and 12 were tested for the control of mites on avocado plants. One gram of each sample was mixed with 98 grams of water and 1 gram of sodium lauryl sulfate (as emulsifier). An equivalent amount of clove oil was also diluted as noted above and tested separately. Each diluted sample was sprayed onto 4 avocado plants infested with mites. The results are as follows:

| | Mites | Dead Mites | |
|---|---|---|---|
| | (Before Spraying) | (After Spraying) | Mortality (%) |
| Sample 10 | 45 | 45 | 100.0 |
| Sample 11 | 30 | 27 | 90.0 |
| Sample 12 | 28 | 25 | 89.3 |
| Clove Oil | 32 | 25 | 78.1 |
| Soybean Oil | 34 | 14 | 41.2 |
| Rapeseed Oil | 38 | 15 | 39.5 |
| Vegetable Oil | 31 | 11 | 35.5 |
| Water | 40 | 10 | 25.0 |

Results from Experiment 3 indicate that mixing clove oil (volatile oil) with non-volatile oils in a 40/60 ratio is more effective than using clove oil alone on controlling mites on avocado plants. The combination of clove and soybean oils was completely effective, while clove/rapeseed and clove/vegetable were at least 89% effective. The control rate of diluted clove/non-volatile oils exceeded the control rate of diluted clove oil by at least 14% indicating a synergistic or improved pesticidal effect when a volatile and a non-volatile oil are combined.

### Experiment 4 (Control of Mites on Avocado Plants)

Volatile sweet orange oil was evaluated against and in combination with one of the following non-volatile oils: soybean oil, rapeseed oil, or vegetable oil. Water was also used as a base standard. Samples 13, 14 and 15 were tested for the control of mites on avocado plants. One gram of each sample was mixed with 98 grams of water and 1 gram of sodium lauryl sulfate (as emulsifier). An equivalent amount of sweet orange oil was also diluted as noted above and tested separately. Each diluted sample was sprayed onto 4 avocado plants infested with mites. The results are as follows:

| | Mites | Dead Mites | |
|---|---|---|---|
| | (Before Spraying) | (After Spraying) | Mortality (%) |
| Sample 13 | 35 | 35 | 100.0 |
| Sample 14 | 40 | 35 | 87.5 |
| Sample 15 | 35 | 30 | 85.7 |
| Sweet Orange Oil | 55 | 35 | 63.6 |
| Soybean Oil | 34 | 14 | 41.2 |
| Rapeseed Oil | 38 | 15 | 39.5 |
| Vegetable Oil | 31 | 11 | 35.5 |
| Water | 40 | 10 | 25.0 |

Results from Experiment 4 indicate that mixing sweet orange oil (volatile oil) with non-volatile oils in a 40/60 ratio is more effective than using sweet orange oil alone on controlling mites on avocado plants. The combination of sweet orange oil and soybean oil was completely effective, while sweet orange/rapeseed and sweet orange/vegetable were at least 85.7% effective. The mortality rate using diluted sweet orange/non-volatile oils exceeded the mortality rate using simply diluted sweet orange oil by at least 34% indicating a synergistic or improved pesticidal effect when a volatile and a non-volatile oil are combined.

### Experiment 5 (Control of Mites on Avocado Plants)

Volatile peppermint oil was evaluated against and in combination with the following non-volatile oils: soybean oil, rapeseed oil, or vegetable oil. Water was also used as a base standard. Samples 16, 17 and 18 were tested for the control of mites on avocado plants. One gram of each sample was mixed with 98 grams of water and 1 gram of sodium lauryl sulfate (as emulsifier). An equivalent amount of peppermint oil was also diluted as noted above and tested separately . Each diluted sample was sprayed onto 4 avocado plants infested with mites. The results are as follows:

| | Mites | Dead Mites | |
|---|---|---|---|
| | (Before Spraying) | (After Spraying) | Mortality (%) |
| Sample 16 | 30 | 30 | 100.0 |
| Sample 17 | 38 | 36 | 94.7 |
| Sample 18 | 30 | 30 | 100.0 |
| Peppermint Oil | 35 | 28 | 80.0 |
| Soybean Oil | 34 | 14 | 41.2 |
| Rapeseed Oil | 38 | 15 | 39.5 |
| Vegetable Oil | 31 | 11 | 35.5 |
| Water | 40 | 10 | 25.0 |

Results from Experiment 5 indicate that mixing peppermint oil (volatile oil) with non-volatile oils in a 40/60 ratio is more effective than using peppermint oil alone on controlling mites on avocado plants. The combination of either peppermint and soybean oils or peppermint and vegetable oils were completely effective, while peppermint/rapeseed was at least 94.7% effective. The mortality rate using diluted peppermint/non-volatile oils exceeded the mortality rate using simply diluted peppermint oil by at least 18% indicating a synergistic effect when a volatile and a non-volatile oil are combined.

### Experiment 6 (Control of Mites on Avocado Plants)

Sample 20 was tested for the control of mites on avocado plants. One gram of the sample was mixed with 98 grams of water and 1 gram of sodium lauryl sulfate (as emulsifier). An equivalent amount of clove oil was diluted for testing. The results for soybean oil previously mentioned are also provided for contrast. Each diluted material was sprayed onto 4 avocado plants infested with mites. The results are as follows:

| | Mites | Dead Mites | |
|---|---|---|---|
| | (Before Spraying) | (After Spraying) | Mortality (%) |
| Sample 20 | 45 | 45 | 100.0 |
| Clove Oil | 33 | 25 | 75.8 |
| Soybean Oil | 34 | 14 | 41.2 |
| Water | 40 | 10 | 25.0 |

Results from Experiment 6 indicate that mixing clove oil (volatile) with non-volatile soybean oil in a 10/90 ratio is more effective than using clove oil alone or soybean oil alone on controlling mites on avocado plants. The combination was completely effective in control of mites and represents a 31% improvement over clove oil and water.

### Experiment 7 (Control of Mites on Avocado Plants)

Sample 21 was tested for the control of mites on avocado plants. One gram of the sample was mixed with 98 grams of water and 1 gram of sodium lauryl sulfate (as emulsifier). An equivalent amount of clove oil was also diluted as noted above and tested separately. Each diluted material was sprayed onto 4 avocado plants with mites. The results are as follows:

| | Mites | Dead Mites | |
|---|---|---|---|
| | (Before Spraying) | (After Spraying) | Mortality (%) |
| Sample 21 | 25 | 25 | 100.0 |
| Clove Oil | 21 | 20 | 95.2 |
| Soybean Oil | 34 | 14 | 41.2 |
| Water | 40 | 10 | 25.0 |

Results from Experiment 7 indicate that mixing clove oil (volatile) with non-volatile soybean oil in a 90/10 ratio is more effective than using clove oil alone on controlling mites on avocado plants. As was expected, the higher concentration of clove oil in this experiment contrasted to Experiment 6 was more effective in controlling mites. Yet the combination of soybean oil and clove oil exhibited complete control of mites.

### Experiment 8

Sample 19 was tested for the control of mites on avocado plants. One gram of the sample was mixed with 98 grams of water and 1 gram of sodium lauryl sulfate (as emulsifier). An equivalent amount of clove and sweet orange oils were also used in the test. The results are as follow:

| | Mites | Dead Mites | |
|---|---|---|---|
| | (Before Spraying) | (After Spraying) | Mortality (%) |
| Sample 19 | 27 | 25 | 92.6 |
| Clove Oil and | 45 | 31 | 68.9 |
| Sweet Orange Oil | | | |
| Soybean Oil | 34 | 14 | 41.2 |
| Water | 40 | 10 | 25.0 |

Results from Experiment 8 indicate that mixing a mixture of clove oil and sweet orange oil (volatile oils) with non-volatile soybean oil in a 40/60 ratio is more effective than the mixture of clove oil and sweet orange oil or soybean oil by itself on controlling mites on avocado plants. The combination represented as Sample 19 was 34.3% more effective than the combination of clove oil and sweet orange oil. This indicates a synergistic or improved pesticidal effect when the volatile oils are combined with soybean oil.

### Experiment 9 (Control of Botrytis Cinerea)

Samples 10, 11 and 12, clove oil, soybean oil, rapeseed oil, and vegetable oil were each diluted with 100 times water. Plant pathogen, Botrytis Cinerea, was grown on petri dishes containing potato destrose agar medium. The petri dishes were allowed to become fully covered by the mycelium of Botrytis Cinerea.

Afterwards, Samples 10, 11, 12, clove oil, soybean oil, rapeseed oil, and vegetable oil were each separately applied to four petri dishes. Four petri dishes were also treated with water only. Each petri dish received one milliliter of the diluted sample and was then shaken horizontally to evenly distribute the sample in the petri dish. Three days after receiving treatment, the petri dishes were observed and areas where the mycelia of Botrytis Cinerea were dead were estimated. The areas of dead mycelia are indicated below as percent inhibition:

| Treatment | % Inhibition |
|---|---|
| Sample 10 | 90 |
| Sample 11 | 80 |
| Sample 12 | 80 |
| Clove Oil | 70 |
| Soybean Oil | 40 |
| Rapeseed Oil | 45 |
| Vegetable Oil | 40 |
| Water | 5 |

Results from Experiment 9 indicate that mixing clove oil with non-volatile oils in a 40/60 ratio is more effective than using clove oil alone or the non-volatile oils alone on inhibiting the growth of Botrytis Cinerea on potato destrose agar medium. The combination of clove oil and soybean oil was the most effective and represents a 28.5% improvement over clove oil.

### Experiment 10 (Control of Botrytis Cinerea)

Samples 13, 14 and 15 and sweet orange oil, were each diluted were each diluted with 100 times water. Plant pathogen, Botrytis Cinerea, was grown on petri dishes containing potato destrose agar medium. The petri dishes were allowed to become fully covered by the mycelium of Botrytis Cinerea.

Afterwards, Samples 13, 14, and 15 were each separately applied to four petri dishes. Four petri dishes were also treated with diluted sweet orange oil. Each petri dish received one milliliter of the diluted sample and was then shaken horizontally to evenly distribute the sample in the petri dish. Three days after receiving the treatments the petri dishes were observed and areas where the mycelia of Botrytis Cinerea were dead were estimated. The areas of dead mycelia are indicated below as percent inhibition. Also shown for comparison are the results for soybean oil, rapeseed oil, vegetable oil and water as was reported in Experiment 9.

| Treatment | % Inhibition |
|---|---|
| Sample 13 | 80 |
| Sample 14 | 70 |
| Sample 15 | 70 |
| Sweet Orange Oil | 40 |
| Soybean Oil | 40 |
| Rapeseed Oil | 45 |
| Vegetable Oil | 40 |
| Water | 5 |

Results from Experiment 10 indicate that mixing sweet orange oil with non-volatile oils in a 40/60 ratio is more effective than using sweet orange oil alone or any of the non-volatile oils alone on inhibiting the growth of Botrytis Cinerea on potato distress agar medium. Rapeseed oil showed better inhibition than sweet orange oil. However, when rapeseed oil was combined with sweet orange oil, the combination indicated a 55.5% improvement while the combination of soybean oil and sweet orange oil indicated a 100% improvement.

### Experiment 11 (Control of Botrytis Cinerea)

Samples 16, 17, 18, and peppermint oil were each diluted with 100 times water. Plant pathogen, Botrytis Cinerea, was grown on petri dishes containing potato destrose agar medium. The petri dishes were allowed to become fully covered by the mycelium of Botrytis Cinerea.

Afterwards, samples 16, 17, 18 and diluted peppermint oil were separately applied to four petri dishes. Each petri dish received one milliliter of the diluted sample and was then shaken horizontally to evenly distribute the sample in the petri dish. Three days after receiving the treatments the petri dishes were observed and areas where the mycelia of Botrytis Cinerea were dead were estimated. Also shown for comparison are the results for soybean oil, rapeseed oil, vegetable oil and water as was reported in Experiment 9. The areas where the mycelia were dead are shown below as percent inhibition:

| Treatment | % Inhibition |
|---|---|
| Sample 16 | 70 |
| Sample 17 | 80 |
| Sample 18 | 85 |
| Peppermint Oil | 60 |
| Soybean Oil | 40 |
| Rapeseed Oil | 45 |
| Vegetable Oil | 40 |
| Water | 5 |

Results from Experiment 11 indicate that mixing peppermint oil with non-volatile oils in a 40/60 ratio is more effective than using peppermint oil alone or any of the non-volatile oils alone on inhibiting the growth of Botrytis Cinerea on potato destrose agar medium. The combination of peppermint oil and vegetable oil exhibited at least a 41% improvement in inhibition over either peppermint oil or vegetable oil separately.

### Experiment 12 (Control of Botrytis Cinerea)

Sample 20 was diluted with 100 times water. Plant pathogen, Botrytis Cinerea, was grown on petri dishes containing potato destrose agar medium. The petri dishes were allowed to become fully covered by the mycelium of Botrytis Cinerea.

Afterwards, four petri dishes were treated with Sample 20. Each petri dish received one milliliter of the diluted sample and was then shaken horizontally to evenly distribute the sample in the petri dish. Three days after receiving the treatments the petri dishes were observed and areas where the mycelia of Botrytis Cinerea were dead were calculated. An equivalent amount of clove oil was also diluted and tested as above. Also shown for comparison are the results for soybean oil, and water as was reported in Experiment 9. The areas where the mycelia were dead are shown below as percent inhibition:

| Treatment | % Inhibition |
|---|---|
| Sample 20 | 80 |
| Clove Oil | 10 |
| Soybean Oil | 40 |
| Water | 5 |

The results indicate that mixing clove oil with non-volatile soybean oil in a 10/90 ratio is more effective than using clove oil alone on inhibiting Botrytis Cinerea growth on potato destros agar medium.

### Experiment 13 (Control of Botrytis Cinerea)

Sample 21 was diluted with 100 times water and comprises a 90/10 ratio of clove oil to soybean oil. Plant pathogen, Botrytis Cinerea, was grown on petri dishes containing potato distress agar medium. The petri dishes were allowed to become fully covered by the mycelium of Botrytis Cinerea.

Afterwards, four petri dishes were treated with Sample 21. Each petri dish received one milliliter of the diluted sample and was then shaken horizontally to evenly distribute the sample in the petri dish. Three days after receiving the treatments, the areas of dead mycelia of Botrytis Cinerea were estimated. An equivalent amount of clove oil was also diluted and tested as above. Also shown for comparison are the results for soybean oil, and water as was reported in Experiment 9. The areas of dead mycelia are shown below as percent inhibition:

| Treatment | % Inhibition |
|---|---|
| Sample 21 | 90 |
| Clove Oil | 80 |
| Soybean Oil | 40 |
| Water | 5 |

The results indicate that mixing clove oil with non-volatile soybean oil in a 10/90 ratio is more effective than using either clove oil or soybean oil alone on inhibiting Botrytis Cinerea growth on potato destros agar medium.

### Experiment 14 (Control of Botrytis Cinerea)

Sample 19, and a 50/50 blend of sweet orange oil and clove oil were diluted with 100 times water. Plant pathogen, Botrytis Cinerea, was grown on petri dishes containing potato destrose agar medium. The petri dishes were allowed to become fully covered by the mycelium of Botrytis Cinerea.

Afterwards, four petri dishes were treated with Sample 19 and four with the sweet orange oil/clove oil combination. Each petri dish received one milliliter of the diluted samples and was then shaken horizontally to evenly distribute the sample in the petri dish. Three days after receiving the treatments the areas of dead mycelia of Botrytis Cinerea were estimated. Also shown for comparison are the results for soybean oil, and water as was reported in Experiment 9. The areas of dead mycelia are shown below as percent inhibition:

| Treatment | % Inhibition |
|---|---|
| Sample 19 | 70 |
| Clove Oil & Sweet Orange Oil | 50 |
| Soybean Oil | 40 |
| Water | 5 |

The results indicate that mixing clove oil and sweet orange oil with non-volatile oil in a 10/90 ratio is more effective than using a combination of clove oil and sweet orange oil on inhibiting Botrytis Cinerea growth on potato destros agar medium.

### Experiment 15 (Control of Bacillus subtilis)

Samples 10, 11 and 12 were each diluted with 100 times water. Bacterium, Bacillus subtilis, was grown on petri dishes containing nutrient agar medium. After the bacterium was grown to about 3 centimeters in diameter, samples 10, 11, and 12 were applied separately to four respective petri dishes. Four petri dishes were treated with water only. An equivalent amount of clove oil, soybean oil, rapeseed oil, and vegetable oil were each diluted with 100 times water and applied to four petri dishes each. Each petri dish received one milliliter of the diluted sample and was then shaken horizontally to evenly distribute the sample in the petri dish. One day after receiving the treatments, the growing diameters of Bacillus subtilis were measured. The growing diameters of Bacillus subtilis before and one day after receiving the treatments and the percentage of growth inhibition by the treatments are shown below:

| | Growing Diameter (cm) | | |
|---|---|---|---|
| Treatment | Before | After | % Inhibition |
| Sample 10 | 3.0 | 0.3 | 90.0 |
| Sample 11 | 3.1 | 0.4 | 87.1 |
| Sample 12 | 3.0 | 0.2 | 93.3 |
| Clove Oil | 3.5 | 1.2 | 65.7 |
| Soybean Oil | 3.4 | 2.0 | 41.2 |
| Rapeseed Oil | 3.7 | 2.2 | 40.5 |
| Vegetable Oil | 3.2 | 2.1 | 34.4 |
| Water | 2.5 | 2.2 | 12.0 |

The results indicate that combining clove oil with non-volatile oils is more effective than using clove oil alone on inhibiting the growth of Bacillus subtilis on Nutrient Agar medium. Clove oil in combination with soybean oil in a 40/60 ratio (Sample 10) exhibited at least a 36% improvement over using clove oil or soybean oil separately.

### Experiment 16 (Control of Bacillus subtilis)

Samples 13, 14 and 15 were each diluted with 100 times water. Bacterium, Bacillus subtilis, was grown on petri dishes containing nutrient agar medium. After the bacterium was grown to about 3 cm in diameter, four petri dishes were each separately treated with samples 13, 14 and 15. Four petri dishes were treated with an equivalent amount of sweet orange oil diluted with 100 times water. Each petri dish received one milliliter of the diluted sample and was then shaken horizontally to evenly distribute the sample in the petri dish. One day after receiving the treatments the growing diameters of Bacillus subtilis were measured. Also shown for comparison are the results for soybean oil, rapeseed oil, vegetable oil and water as was reported in Experiment 15. The growing diameters of Bacillus subtilis before and one day after receiving the treatments and the percentage of growth inhibition by the treatments are shown below:

| | Growing Diameter (cm) | | |
|---|---|---|---|
| Treatment | Before | After | % Inhibition |
| Sample 13 | 3.7 | 0.8 | 78.4 |
| Sample 14 | 2.9 | 0.6 | 79.3 |
| Sample 15 | 3.0 | 0.5 | 83.3 |
| Sweet Orange Oil | 2.0 | 0.7 | 65.0 |
| Soybean Oil | 3.4 | 2.0 | 41.2 |
| Rapeseed Oil | 3.7 | 2.2 | 40.5 |
| Vegetable Oil | 3.2 | 2.1 | 34.4 |
| Water | 2.5 | 2.2 | 12.0 |

The results indicate that combining sweet orange oil with non-volatile oils is more effective than using sweet orange oil or a non-volatile oil separately on inhibiting the growth of Bacillus subtilis on Nutrient Agar medium. The combination of sweet orange oil with vegetable oil exhibited the highest inhibition, showing a 28% improvement over sweet orange oil.

### Experiment 17 (Control of Bacillus subtilis)

Samples 16, 17 and 18 were each diluted with 100 times of water. Bacterium, Bacillus subtilis, was grown on petri dishes containing nutrient agar medium. After the bacterium was grown to about 3 cm in diameter, four petri dishes were treated with each one of the samples. Four petri dishes were also treated with equivalent amount of peppermint oil diluted as mentioned above. Each petri dish received one milliliter of the diluted sample and was then shaken horizontally to evenly distribute the sample in the petri dish. One day after receiving the treatments the growing diameters of Bacillus subtilis were measured. Also shown for comparison are the results for soybean oil, rapeseed oil, vegetable oil and water as was reported in Experiment 15. The growing diameters of Bacillus subtilis before and one day after receiving the treatments and the percentage of growth inhibition by the treatments are shown below:

| | Growing Diameter (cm) | | |
|---|---|---|---|
| Treatment | Before | After | % Inhibition |
| Sample 16 | 3.5 | 0.8 | 77.1 |
| Sample 17 | 3.2 | 0.9 | 71.9 |
| Sample 18 | 3.5 | 1.0 | 71.4 |
| Peppermint Oil | 3.0 | 1.3 | 56.7 |
| Soybean Oil | 3.4 | 2.0 | 41.2 |
| Rapeseed Oil | 3.7 | 2.2 | 40.5 |
| Vegetable Oil | 3.2 | 2.1 | 34.4 |
| Water | 2.5 | 2.2 | 12.0 |

The results indicate that peppermint oil in combination with a non-volatile oil is more effective than peppermint oil alone on inhibiting the growth of Bacillus subtilis on Nutrient Agar medium. Peppermint oil in combination with soybean oil exhibited the most inhibition, a 35% improvement over peppermint oil treatment.

We claim:

1. A concentrated natural pesticide comprising:
at least one non-volatile oil component;
at least one volatile oil component; and,
the ratio of said non-volatile oil component to said volatile oil component is in the range between one to ten and ten to one by weight; and when said concentrated natural pesticide is diluted with water, the combination of said non-volatile component and said volatile oil component exhibits improved pesticidal effectiveness than if either an equivalent amount of said non-volatile oil component or said volatile oil component were used alone.

2. A concentrated natural pesticide comprising:
a non-volatile oil component, selected from the group consisting of cottonseed oil, corn oil, mineral oil, soybean oil, rapeseed oil, and vegetable oil;
a volatile oil component, selected from the group consisting of cinnamon oil, rosemary oil, cedarwood oil, clove oil, sweet orange oil, and peppermint oil; and,
the ratio of said non-volatile oil component to said volatile oil component is in the range between one to ten and ten to one by weight; and when said concentrated natural pesticide is diluted with water, the combination of said non-volatile component and said volatile oil component exhibits improved pesticidal effectiveness than if either an equivalent amount of said non-volatile oil component or said volatile oil component were used alone.

3. A concentrated natural pesticide comprising:
a non-volatile oil component, selected from the group consisting of cottonseed oil, corn oil, mineral oil, soybean oil, rapeseed oil, vegetable oil, and fish oil;
a volatile oil component, selected from the group consisting of cinnamon oil, rosemary oil, cedarwood oil, clove oil, sweet orange oil, peppermint oil, citronella oil, pine oil, citrus oil, eucalyptus oil, and camphor oil; and,
the ratio of said non-volatile oil component to said volatile oil component is in the range between one to ten and ten to one by weight; and when said concentrated natural pesticide is diluted with water, the combination of said non-volatile component and said volatile oil component exhibits improved pesticidal effectiveness than if either an equivalent amount of said non-volatile oil component or said volatile oil component were used alone.

4. A natural pesticide comprising:
a non-volatile oil component, selected from the group consisting of cottonseed oil, corn oil, mineral oil, soybean oil, rapeseed oil, vegetable oil, and fish oil;
a volatile oil component, selected from the group consisting of cinnamon oil, rosemary oil, cedarwood oil, clove oil, sweet orange oil, peppermint oil, citronella oil, pine oil, citrus oil, eucalyptus oil, and camphor oil;
water to dilute said components up to 2000 times; and,
the ratio of said non-volatile oil component to said volatile oil component is in the range between one to ten and ten to one by weight; and wherein the diluted combination of said non-volatile component and said volatile oil component exhibits improved pesticidal effectiveness than if either an equivalent amount of said non-volatile oil component or said volatile oil component were diluted and used alone.

5. The concentrated natural pesticide of claim 1 which further comprising an emulsifier, said emulsifier being between 1%-60% of the weight of said concentrated natural pesticide.

6. The concentrated natural pesticide of claim 5 wherein said emulsifier is sodium lauryl sulfate.

7. The concentrated natural pesticide of claim 2 which further comprising an emulsifier, said emulsifier being between 1%-60% of the weight of said concentrated natural pesticide.

8. The concentrated natural pesticide of claim 7 wherein said emulsifier is sodium lauryl sulfate.

9. The concentrated natural pesticide of claim 3 which further comprising an emulsifier, said emulsifier being between 1%-60% of the weight of said concentrated natural pesticide.

10. The concentrated natural pesticide of claim 9 wherein said emulsifier is sodium lauryl sulfate.

11. The natural pesticide of claim 4 which further comprising an emulsifier, said emulsifier being between 1%-60% of the weight of said concentrated natural pesticide.

12. The natural pesticide of claim 11 wherein said emulsifier is sodium lauryl sulfate.
